(19) United States
(12) Patent Application Publication
(10) Pub. No.: US 2022/0341847 A1
(43) Pub. Date: Oct. 27, 2022

(54) ODOUR IDENTIFICATION DEVICE, ODOUR IDENTIFICATION METHOD AND CORRESPONDING COMPUTER PROGRAM

(71) Applicant: ARYBALLE, GRENOBLE (FR)

(72) Inventors: Yanis CARITU, GRENOBLE (FR); Loïc LAPLATINE, GRENOBLE (FR); Delfina FAINGUERSCH, GRENOBLE (FR)

(21) Appl. No.: 17/762,254

(22) PCT Filed: Sep. 10, 2020
(86) PCT No.: PCT/FR2020/051556

§ 371 Date: Mar. 21, 2022

(30) Foreign Application Priority Data
Sep. 19, 2019 (FR) FR1910335

(51) Int. Cl. G01N 21/552

(52) U.S. Cl. CPC G01N 21/553

(57) ABSTRACT

An odor identification device includes capture sites designed to capture odorous volatile organic compounds present in an ambient air; an imaging system for imaging the capture sites designed to provide at least one raw image of the capture sites. The device further includes an unblurring module designed to implement an unblurring filter using an estimate of a spatial impulse response of the imaging system, on an image to be unblurred that originates from at least one raw image of the capture sites; and a module for identifying an odor from at least one image of the capture sites unblurred by the unblurring module.

The present invention relates to an odor identification device, an odor identification method and a corresponding computer program.

Aryballe's NeOse Pro (registered trademark) product, launched in 2018, is an odor identification device comprising:
capture sites designed to capture odorous volatile organic compounds in ambient air;
an imaging system for imaging the capture sites, designed to provide at least one raw image of the capture sites (107).

This well-known device further comprises a module for identifying an odor from images provided by the camera.

For reasons of space and mechanical robustness, this well-known device does not have a focusing device to focus the light on the camera. As a result, the raw images provided by the camera are blurred. Thus, odor identification is carried out using blurred images, which can degrade the identification results.

It may thus be desirable to provide an odor identification device that avoids at least some of the above problems and constraints.

It is therefore proposed an odor identification device comprising:
capture sites designed to capture odorous volatile organic compounds in an ambient air;
an imaging system for imaging the capture sites designed to provide at least one raw image of the capture sites;

characterized in that it further comprises:
an unblurring module designed to implement an unblurring filter using an estimate of a spatial impulse response of the imaging system, on an image to be unblurred that originates from at least one raw image of the capture sites; and
a module for identifying an odor from at least one image of the capture sites unblurred by the unblurring module.

Thus, odor identification is efficient without the need for a focusing device in the imaging system.

Optionally, the imaging system comprises:
a metal layer with a first side in contact with the ambient air and to which the capture sites are attached, and a second side opposite the first side;
a device for illuminating the second side of the metal layer with collimated light, designed to produce a surface plasmon resonance on the first side of the metal layer, so that a reflectivity of the second side of the metal layer varies locally in the vicinity of each capture site as a function of the compound(s) captured by that capture site; and
a camera arranged to receive collimated light that has been reflected by the second side of the metal layer, and designed to provide the raw image(s) of the capture sites.

Also optionally, the unblurring filter is a Wiener filter comprising multiplication of a quantity W equal to E*/(|E|²+K) where E is the estimate in spectral form of the spatial impulse response of the imaging system, E* is the conjugate of this estimate E and K is a parameter, with the image to be unblurred in spectral form.

Also optionally, the unblurring filter is an inverse filter comprising the multiplication of an inverse of the estimate in spectral form of the spatial impulse response of the imaging system with the image to be unblurred in spectral form.

Also optionally, the identification module is designed to use at least one unblurred image of the capture sites in presence of odor in the ambient air and at least one unblurred image of the capture sites in absence of odor in the ambient air.

Also proposed is an odor identification method using an odor identification device comprising:
capture sites designed to capture odorous volatile organic compounds in an ambient air;
an imaging system for imaging the capture sites designed to provide at least one raw image of the capture sites (107);

the method being characterized in that it comprises:
an unblurring step implementing an unblurring filter using an estimate of a spatial impulse response of the imaging system, on an image to be unblurred that originates from at least one raw image of the capture sites; and
a step for identifying an odor from at least one unblurred image of the capture sites.

Optionally, the method further comprises, prior to the unblurring step:
a step for determining the spatial impulse response estimate of the imaging system; and
a step for configuring an unblurring module of the odor identification device so that this unblurring module implements the unblurring step.

Also optionally, the spatial impulse response estimate of the imaging system is a predefined shape parameterized according to at least one parameter, and the step for determining the spatial impulse response estimate of the imaging system comprises determining the parameter(s) of the predefined shape.

Also optionally, the method further comprises a step for determining at least one parameter of the unblurring filter.

It is also proposed a computer program downloadable from a communication network and/or recorded on a computer-readable medium and/or executable by a processor, characterized in that it comprises instructions for executing the steps of a method according to the invention, when said program is executed on a computer.

The invention will be better understood with the aid of the following description, which is given solely by way of example and is made with reference to the appended drawings wherein:

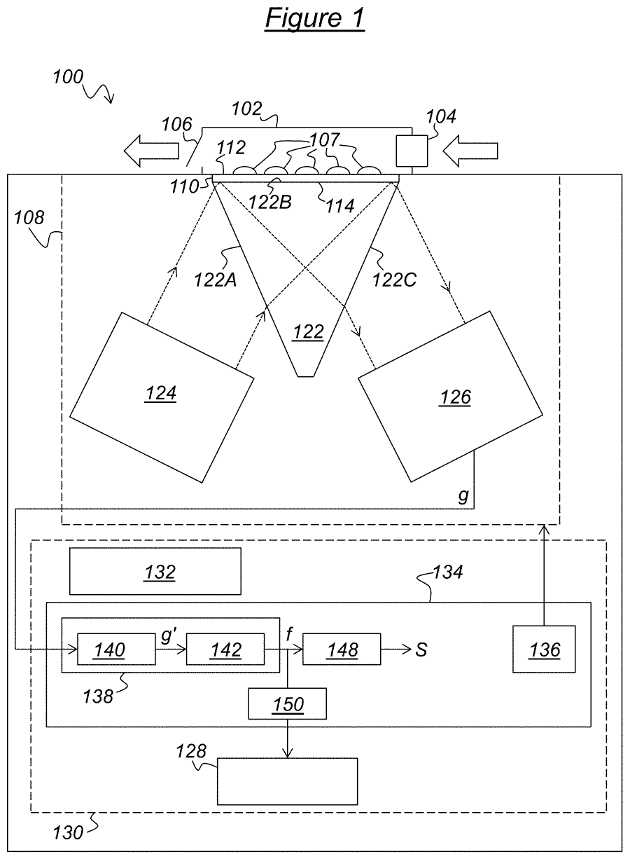

FIG. 1 schematically represents the general structure of an odor detection device, according to an embodiment of the invention,

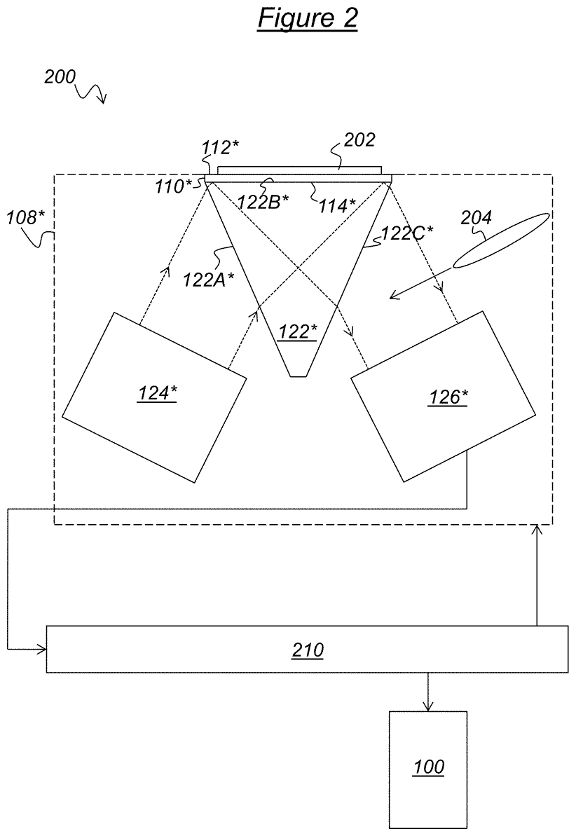

FIG. 2 illustrates a configuration system, according to an embodiment of the invention, of the odor detection device of FIG. 1,

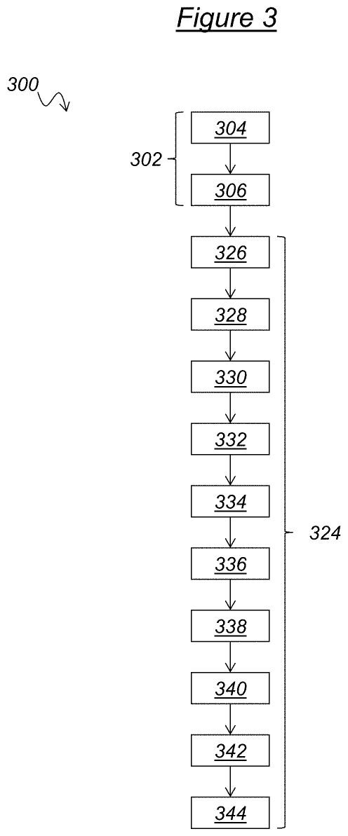

FIG. 3 illustrates the successive steps of an odor detection method, according to an embodiment of the invention,

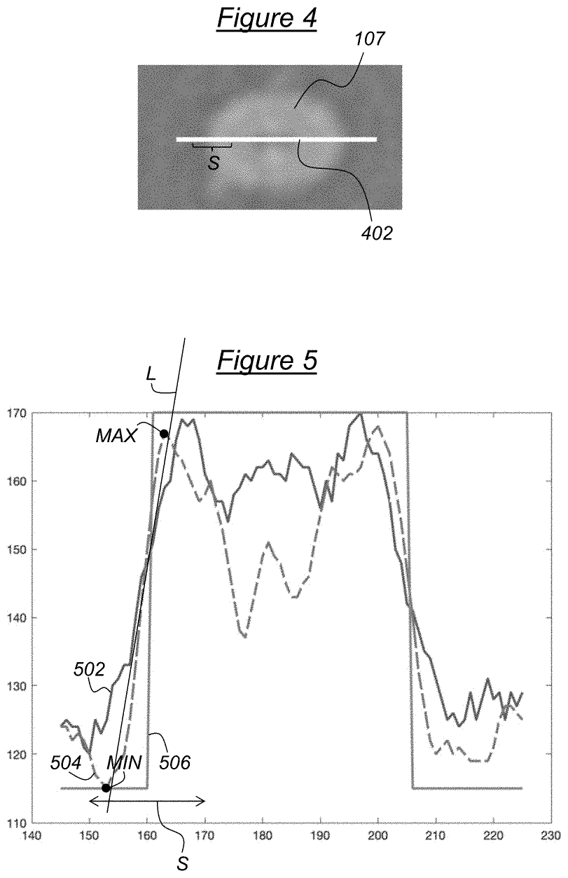

FIG. 4 shows a portion of an image surrounding a capture site and a line running through it,

FIG. 5 shows the luminance values of the pixels along the line in FIG. 4,

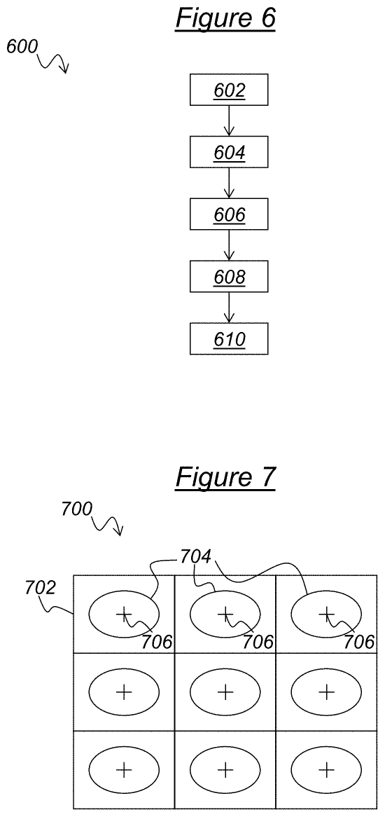

FIG. 6 illustrates the successive steps of a method for updating a map of capture sites, according to an embodiment of the invention,

FIG. 7 shows a map of capture sites,

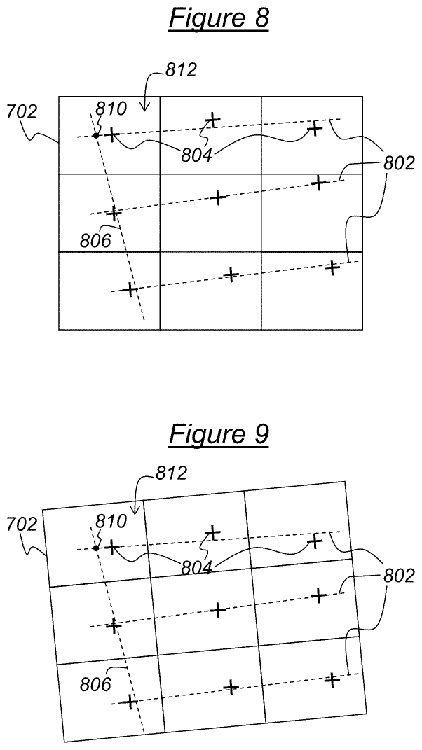

FIG. 8 shows a configuration of the capture site map when it is updated,

FIG. 9 shows the result of updating a position and orientation of a grid of the capture site map in FIG. 7, and

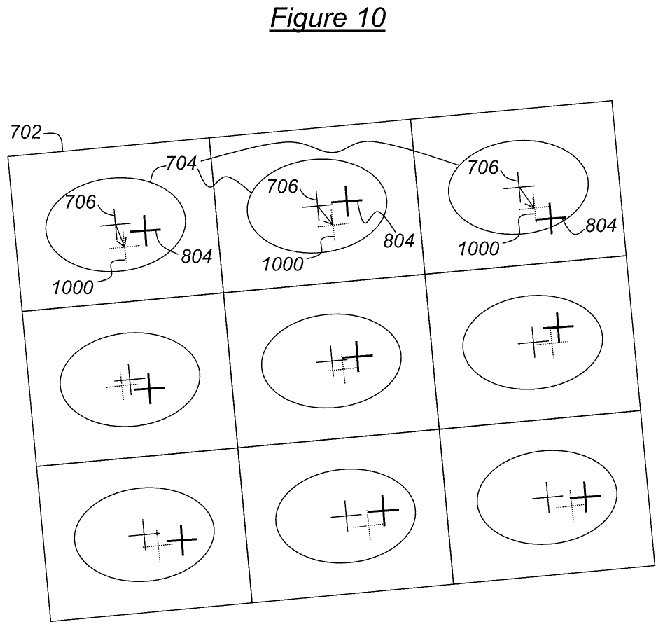

FIG. 10 shows the result of updating the positions of ellipses in the grid cells of the capture site map.

With reference to FIG. 1, an example of an odor detection device 100 according to the invention will now be described.

The device 100 first comprises a chamber 102 for receiving ambient air.

The device 100 further comprises a suction device 104 designed to draw air from outside the chamber 102 into the chamber 102.

The device 100 further comprises an air outlet 106 which can be selectively closed to keep the ambient air in the chamber 102 or opened to allow the ambient air to be evacuated from the chamber 102 and renewed by activation of the suction device 104.

The device 100 further comprises, within the chamber 102, capture sites 107 designed to capture odorous volatile organic compounds that may be present in the ambient air of the chamber 102. Each capture site 107 is, for example, designed to capture compounds of a particular family of compounds. Each capture site 107 comprises, for example, a molecule, such as a peptide, complementary to the compounds of the family associated with that capture site 107.

The device 100 further comprises an imaging system 108 for imaging the capture sites 107.

The imaging system 108 first comprises a metal layer 110, for example gold, having a first side 112 facing into the chamber 102 so as to be in contact with the ambient air contained in the chamber 102. The capture sites 107 are attached to this first side 112 at predefined positions. In the example described, the capture sites 107 are aligned on a positioning grid, i.e., they are respectively at the centers of cells of this positioning grid. The metal layer 110 further has a second side 114, opposite the first side 112.

The imaging system 108 further comprises a prism 122 having a light input side 122A, a side 122B against which the metal layer 110 extends and a light output side 122C.

The imaging system 108 further includes an illumination device 124 designed to illuminate the second side 114 of the metal layer 110 with collimated light. Specifically, the collimated light is emitted by the illumination device 124 through the light input side 122A of the prism 122 to the second side 114 of the metal layer 110.

Since the second side 114 of the metal layer 110 has some reflectivity, some of the collimated light is reflected. However, the illumination device 124 is further designed to produce a surface plasmon resonance on the first side 112 of the metal layer 110. This resonance reduces the reflectivity of the second side 114 of the metal layer 110 and is sensitive to the refractive index of the air present up to about 100 nanometers above the first side 112 of the metal layer 110, and thus in particular above the capture sites 107 which have a smaller thickness. However, the capture of a compound by a capture site 107 modifies the refractive index of the air above the capture site 107 and thus decreases the reflectivity of the second side 114 of the metal layer 110.

Thus, the reflectivity of the second side 114 of the metal layer 110 varies locally in the vicinity of, and in particular above, each capture site 107 as a function of the compound(s) captured by that capture site 107.

To produce plasmon resonance, the illumination device 124 is preferably designed to emit transverse magnetic polarization light, noted TM, i.e., having a magnetic field parallel to the second side 114 of the metal layer 110. The illumination device 124 may further be designed to emit transverse electrically polarized light, denoted TE, instead of TM light, i.e., having an electric field parallel to the second side 114 of the metal layer 110, on command. Furthermore, the prism 122 serves to obtain an angle of incidence at the entrance to the metal layer 110 (i.e., when the prism 122 is present, at the glass (of the prism 122)/metal layer 110 interface) allowing the surface plasmon resonance.

The imaging system 108 further comprises a camera 126 arranged to receive light emitted by the illumination device 124, having been reflected from the second side 114 of the metal layer 110 and having passed through the light exit side 122C of the prism 122. The camera 126 is designed to provide at least one raw image, each noted as g, of the capture sites 107 from the received light. In the example described, the raw images g are images of luminance expressed as a single number, so that the raw images are greyscale images.

It will be appreciated that the imaging system 108 does not include a focusing lens between the light exit side 122C of the prism 122 and the camera 126 so that the light received by the camera 126 is collimated, i.e., it does not substantially converge towards the camera 126. As a result, each raw image g provided by the camera 126 is blurred.

The device 100 further comprises a memory 128 in which unblurring data D from an estimate E of a spatial impulse response (called PSF from the English “Point Spread Function”, which can also be translated into French by “fonction d′étalement du point”) of the imaging system 108 is stored. As is well known, the PSF is a set of data describing the response of the imaging system 108 to a point excitation or to an imaged point object. The PSF estimate E may be expressed in spectral form, i.e., in the spatial frequency domain (e.g., as a Fourier transform), or in real form (i.e., as an image).

In addition, a map of the capture sites 107 is also stored in the memory 128.

With reference to FIG. 7, the map (labelled 700) shows the respective positions of the areas occupied by the capture sites 107 in the images of the capture sites 107.

More specifically, the map 700 includes capture site shapes 704 having respective predefined positions in the map 700 and intended to be placed on an image of the capture sites 107 at a predefined position and orientation, referred to as an overlay. Thus, the capture site shapes 704 respectively indicate the areas of the image occupied by the capture sites 107. In the example described, the map 700 comprises a grid 702 delimiting cells in which the capture site shapes 704 are respectively located. Each capture site shape 704 thus has a predefined position in its respective cell.

In the example described, the capture sites 107 are circular, but due to the tilt of the camera 126 relative to the second side 114 of the metal layer 110, the areas they occupy in the images are ellipses. Thus, in the example described, the shapes of the capture sites 704 in the map 700 are ellipses, each positioned in the respective cell by their center 706.

Returning to FIG. 1, the device 100 further comprises a number of functional modules which will be described below. In the example described, these modules are software modules. Thus, the device 100 includes a computer 130 having a processing unit 132 and an associated memory 134 in which one or more computer programs are stored. The one or more computer programs include instructions designed to be executed by the processing unit 132 to perform the functions of the modules. Alternatively, some or all of the functions of the modules could be micro-programmed or micro-wired into dedicated integrated circuits, such as digital circuits. In particular, alternatively, the computer 130 could be replaced by an electronic device consisting solely of digital circuits (without a computer program) for implementing the same functions.

The device 100 thus first comprises a control module 136 for the suction device 104, the outlet 106 and the imaging system 108.

The device 100 further comprises an unblurring module 138 designed to provide at least one unblurred image f of the capture sites 107, each from, on the one hand, at least one raw image g provided by the camera 126 and, on the other hand, the estimate E of the PSF stored in the memory 128.

In the described example, the unblurring module 138 first includes a denoising sub-module 140 designed to provide a denoised image g′ from at least one raw image g. To cancel noise, the denoising sub-module 140 uses, for example, a so-called noise image, denoted gₙₒᵢₛₑ, representative of imperfections in the light input and output sides 122A, 122C of the prism 122 that cause noise to be present in the raw images g provided by the camera 126.

In the example described, each denoised image is obtained from a single raw image g. Thus, the raw image g is for example divided, pixel by pixel, by the noise image gₙₒᵢₛₑ, according to the formula g′=g/gₙₒᵢₛₑ. Alternatively, in the case where each denoised image g′ is obtained from several raw images g, an average image of the raw images g, denoted avg(g), can for example be divided, pixel by pixel, by the noise image gₙₒᵢₛₑ, according to the formula g′=avg(g)/gₙₒᵢₛₑ.

Furthermore, rather than dividing the entire image (raw image g or the average avg(g) of the raw images g), only the areas of the capture sites 107 in the image, as defined in map 700, can be respectively divided by the corresponding areas of the noise image gₙₒᵢₛₑ.

The noise image gₙₒᵢₛₑ is, for example, stored in memory 128 and used for several odor detections. The noise image gₙₒᵢₛₑ may furthermore be updated regularly.

The noise image gₙₒᵢₛₑ is obtained for example by using TE light in the imaging system. In this case, the control module 136 is configured to control the illumination device 124 to emit TE light (not causing surface plasmon resonance), and then to control the camera 126 to provide at least one raw image. The noise image gₙₒᵢₛₑ is then obtained from this or these raw images. For example, the noise image gₙₒᵢₛₑ is this raw image (when a single raw image is used) or an average of these raw images (when several raw images are used).

In the described example, the unblurring module 138 further comprises an unblurring sub-module 142 designed to implement an unblurring filter using the PSF estimate E, on an image to be unblurred that originates from at least one raw image of the capture sites provided by the camera. In the example described, the unblurring sub-module 142 is designed to implement the unblurring filter on each denoised image g′, to provide each time an unblurred image f. Alternatively, the denoising sub-module 140 may not be present. In this case, the unblurring sub-module 142 would be designed to unblur each raw image g.

According to a preferred embodiment of the invention, the unblurring sub-module 142 is designed to implement a Wiener filter using the PSF estimate E. The Wiener filter comprises the multiplication of a quantity W by the image to be unblurred (in spectral form):

F=W×G′ [Math. 1]

where G′ is the image to be unblurred (in spectral form), F the unblurred image (in spectral form) and W is given by:

$$W = \frac{{E}^{*}}{{\vert E \vert}^{2} + K} \qquad [ Math . 2 ]$$

where E is the estimate (in spectral form) of the PSF, E* is the conjugate of the estimate E and K is a noise related parameter.

In a further embodiment of the invention, the unblurring sub-module 142 is designed to implement an inverse filter, whereby an inverse of the PSF estimate E is multiplied to the image to be unblurred:

F=E⁻¹×G′ [Math. 3]

where G′ is the image to be unblurred (in spectral form), F is the unblurred image (in spectral form) and E is the estimate (in spectral form) of the PSF.

According to yet another embodiment of the invention, the unblurring sub-module 142 is designed to implement a pseudo-inverse filter. To this end, the unblurring sub-module 142 is first designed to remove (i.e., set to zero), in the estimate E (in spectral form) of the PSF, spatial frequencies below a predefined threshold, to obtain a new estimate E′. Next, the unblurring sub-module 142 is designed to implement the inverse filter from the new estimate E′:

F=G′×E′⁻¹ [Math. 4]

where G′ is the image to be unblurred (in spectral form), F is the unblurred image (in spectral form) and E′ is the E-estimate (in spectral form) of the PSF with the low spatial frequencies removed.

It will be noted that the removal of low spatial frequencies could be performed beforehand, so that it is the E′ estimate that is used as the PSF estimate. In this case, the implementation of the pseudo-inverse filter would be the same as implementing the inverse filter from the E′ estimate.

To implement the unblurring filter, the unblurring sub-module 142 is designed to retrieve the unblurring data D stored in memory 128 and to perform an unblurring operation using that unblurring data D.

Several implementations of the unblurring filter are possible.

For example, when the unblurring filter is the Wiener filter, the unblurring data D may contain the estimate E in spectral form:

D=E [Math. 5]

and the unblurring operation is then:

$$F = \frac{{D}^{*}}{{\vert D \vert}^{2} + K} \times {G}^{′} \qquad [ Math . 6 ]$$

Alternatively, the unblurring data D may contain the quantity W:

$$D = W = \frac{{E}^{*}}{{\vert E \vert}^{2} + K} \qquad [ Math . 7 ]$$

and the unblurring operation is then:

F=D×G′ [Math. 8]

Similarly, when the unblurring filter is the inverse filter, the unblurring data D may contain the estimate E (in spectral form) of the PSF:

D=E [Math. 9]

and the unblurring operation is then:

F=D⁻¹×G′ [Math. 10]

Alternatively, the unblurring data D may contain the inverse of the estimate E (in spectral form) of the PSF:

D=E⁻¹ [Math. 11]

and the unblurring operation is then:

F=D×G′ [Math. 12]

In addition, the unblurring data D could be in image form, not spectral form, so that the unblurring operation would be a convolution rather than a multiplication.

The device 100 further comprises an odor detection module 148 designed to detect an odor from the at least one unblurred image f. In the example described, the odor detection module 148 is designed to receive, on the one hand, at least one unblurred image of the capture sites 107 in the absence of odor, serving as a reference and each denoted f_{ref}, and, on the other hand, at least one other unblurred image of the capture sites 107 in the presence of odor, each denoted f_{odor}. More specifically, the detection module 148 is designed to determine, for each capture site area 107 indicated in the map 700, a visual feature of that area, on the one hand, in the unblurred reference image(s) f_{ref} and, on the other hand, in the unblurred odor image(s) f_{odor}. The visual feature is, for example, an average over the unblurred reference images f_{ref}, respectively over the unblurred odor images f_{odor}, of an average luminance value of the pixels of the capture site 107 area under consideration. The detection module 148 is then designed to determine, for each capture site 107 area, a difference between the visual feature of that area in the absence of odor and the visual feature of that area in the presence of odor. In the example described, the detection performed by the detection module 148 includes providing a signature S of the odor. Thus, the odor detection module 148 is, for example, arranged to provide the odor signature S aggregating the differences thus obtained.

The device 100 further comprises a module 150 for updating the map 700 of capture sites 107.

With reference to FIG. 2, an example of a configuration system 200 according to the invention will now be described.

The configuration system 200 first includes a reference imaging system 108* similar to the imaging system 108, and in particular including similar elements as described above. Thus, the elements of the reference imaging system 108*will not be described again and will be marked with references identical to the references of the elements of the imaging system 108, with an asterisk in addition. For example, prism 122* of reference imaging system 108* corresponds to prism 122 of imaging system 108.

The reference imaging system 108* may be the imaging system 108 that is subsequently carried in the odor detection device 100. Alternatively, the reference imaging system 108* may be an imaging system separate from that of the odor detection device 100, but nevertheless sufficiently similar to the imaging system 108 so that experiments conducted with the reference imaging system 108* are transferable to the imaging system 108.

The configuration system 200 further comprises a test pattern 202 placed on the top side 112* of the metal layer 110, so that the reference imaging system 108* can image it. The test pattern 202 is an object having a predefined and known pattern. The test pattern 202 may be an object having opaque areas and transparent areas. The test pattern 202 may also include the capture sites 107, as their positions are known, for example from the map 700 of the capture sites 107.

The configuration system 200 further comprises a focusing device 204, such as a focus lens, designed to be placed between the second side 114* of the metal layer 110*and the camera 126* (and more precisely between the prism 122*and the camera 126*) of the reference imaging system 108* in order to converge the light towards the camera 126*.

The configuration system 200 further comprises a configuration unit 210, the functions of which will be described below, when describing the method in FIG. 3. In the example described, the configuration unit 210 comprises a computer having a processing unit and an associated memory in which one or more computer programs are stored. The one or more computer programs comprise instructions to be executed by the processing unit to perform the functions of the configuration unit 210. Alternatively, some or all of these functions could be micro-programmed or micro-wired into dedicated integrated circuits, such as digital circuits. In particular, alternatively, the computer could be replaced by an electronic device consisting solely of digital circuits (without a computer program) for implementing the same functions.

With reference to FIG. 3, an example of an odor detection method 300 implementing the invention will now be described.

The method 300 first comprises a configuration phase 302 of the odor detection device 100.

To this end, in a step 304, the configuration unit 210 determines an estimate E of a PSF of the reference imaging system 108* and an unblurring filter using the estimate E. Since the reference imaging system 108* is close to the imaging system 108, the estimate E is also a good estimate of the PSF of the imaging system 108.

This estimate is, for example, carried out on the basis of, on the one hand, a blurred image of a test pattern 202, obtained from the reference imaging system 108* and, on the other hand, a clear image of this test pattern 202.

The blurred image is, for example, the result of a denoising operation from one or more raw images provided by the camera 126* of the reference imaging system 108*, when the focusing device 204 is removed so that the camera 126* provides blurred raw images. The denoising method is, for example, the same as that implemented by the denoising module 140 of the odor detection device 100. Alternatively, denoising could be omitted and the blurred image g_{F} could be a raw image or an average of raw images.

The clear image is, for example, the result of a denoising operation from one or more raw images provided by the camera 126* of the reference imaging system 108*, when the focusing device 204 is in place to converge the light to the camera 126* so that the camera 126* provides clear raw images. Again, the denoising method is, for example, the same as that implemented by the denoising module 140 of the odor detection device 100. Alternatively, denoising could be omitted and the clear image could be a raw image or an average of raw images.

Alternatively, the clear image could be a plane of the test pattern 202 (for example obtained from the map 700 when the test pattern 202 includes the capture sites 107). Thus, the clear image could be obtained without using the reference imaging system 108*, so that there would be no need to provide the focusing device 204.

There are several ways to determine the estimate E.

According to an embodiment of the invention, the estimate E is an image comprising a predefined shape parameterized according to at least one parameter and, during step 304, the configuration unit 210 determines this parameter or these parameters. For example, the predefined shape is a solid disc (high value inside, low value outside) with a diameter as a parameter. For example too, the predefined shape is a two-dimensional Gaussian with a diameter as a parameter.

According to another embodiment of the invention, the estimate E is obtained by experimentation. For example, the control module 216 implements a multiplication of a spectral representation G_{F} of the blurred image with the inverse of a spectral representation G_{N} of the clear image:

E=G_{F}×(G_{N})⁻¹ [Math. 13]

Furthermore, as explained when describing the odor detection device 100, the unblurring filter may be a Wiener, filter, an inverse filter, or a pseudo-inverse filter. Thus, the unblurring filter may be parameterized according to one or more parameters.

An example of determining the parameter(s) of the estimate E and/or the unblurring filter is as follows.

To determine the one or more parameters, the configuration unit 210 obtains a blurred image of a test pattern 202 from the reference imaging system 108*. As described above, the blurred image is, for example, a raw image provided by the camera 126* or a denoised image that originates from one or more raw images.

The configuration unit 210 unblurs the image several times by applying the chosen unblurring filter to it, and each time using different values for the parameter(s) of the unblurring filter and/or estimate E that it uses.

The configuration unit 210 selects the parameter(s) to obtain an unblurred image close to a clear image of the test pattern 202 according to a predefined proximity criterion. The clear image is for example obtained in the same way as described above.

The proximity criterion comprises, for example, maximization of a quantity derived from at least one average luminance gradient over a segment located in the blurred image at a location where, according to the clear image, a luminance step (with a very high luminance gradient) that this segment passes through is expected to be located.

For example, with reference to FIG. 4, when the test pattern 202 includes the capture sites 107, the segment S may belong to a line 402 passing through one of the capture sites 107. Thus, the configuration unit 210 obtains the luminance values of the pixels of the line 402 and in particular of the segment S that crosses the luminance step corresponding to the periphery of the capture site 107.

FIG. 5 shows the luminance values (ordinate) as a function of the pixels (abscissa) along line 402 and in particular along segment S, for the image to be unblurred 502, for the unblurred image 504 and for the clear image 506.

To determine the average gradient, the configuration unit 210 determines, for example, the pixel of maximum luminance MAX and that of minimum luminance MIN on the segment S. The configuration unit 210 then determines the line L that is closest (for example, by the method of least squares) to the luminance values between these two extreme points MAX, MIN. The average gradient then corresponds to the slope of this line.

The operation can be repeated for several capture sites 107, and an average of the average gradients obtained makes it possible to obtain an overall average gradient which the choice of parameter(s) seeks to maximize.

Thus, the parameter or parameters selected are those which make it possible to obtain, in the unblurred image, strong luminance gradients at the periphery of the capture sites 107, which makes it possible to distinguish the capture sites 107 from the background formed by the metal layer 110.

In a step 306, the configuration unit 210 configures the unblurring module 138 (and more specifically, in the example described, the unblurring sub-module 142) to implement the unblurring filter using the PSF estimate E.

For this purpose, the configuration unit 210 stores unblurring data D in the memory 128 and sets up, in the unblurring sub-module 142, an unblurring operation using this unblurring data D to implement the determined unblurring filter.

The method 300 then comprises a use phase 324 performed at each odor detection by the device 100.

In a step 326, the control module 136 controls the suction device 104 and the outlet 106 to fill the chamber 102 with a reference ambient air, i.e., without odor to be detected.

In a step 328, the control module 136 configures the illumination device 124 to emit TM light.

In a step 330, the control module 136 controls the imaging system 108 to provide at least one reference raw image g_{ref} of the capture sites 107.

In a step 332, the denoising sub-module 140 provides a reference denoised image g_{ref} from the reference raw image(s) g_{ref}. Steps 330 and 332 may be repeated to obtain multiple reference denoised images g_{ref}.

In a step 334, the unblurring sub-module 142 unblurs each reference unblurred image g′_{ref}, to provide as many reference unblurred images f_{ref}.

In a step 336, the control module 136 controls the suction device 104 and the outlet 106 to fill the chamber 102 with air containing the odor to be detected.

In a step 338, the control module 136 controls the imaging system 108 to provide at least one raw image of the capture sites 107 in the presence of the odor, denoted g_{odor}.

In a step 340, the denoising sub-module 140 provides a denoised image g_{odor} from the one or more raw images g_{odor}. Steps 330 and 332 may be repeated to obtain multiple denoised images g_{odor}.

In a step 342, the unblurring sub-module 142 unblurs each denoised image g′_{odor}, to provide as many unblurred images f_{odor}.

In a step 344, the odor detection module 148 detects an odor from the reference unblurred image(s) f_{ref} and the unblurred image(s) f_{odor}, as well as from the map 700 of the capture sites 107.

With reference to FIG. 6, a method 600 for updating the map 700 of capture sites 107 will now be described.

The method 600 is, for example, implemented at each odor detection. Alternatively, it may be implemented under control of a user of the odor detection device 100, or at regular or irregular time intervals, in background, without the user being informed.

In a step 602, the update module 150 obtains an image of the capture sites from the imaging system 108, preferably unblurred by the unblurring module 138. For example, the update module 150 uses one of the reference images fret or one of the odor images f_{odor}.

In a step 604, the update module 150 determines, in the obtained image, first real areas respectively occupied by the capture sites 107. This determination may be made in an approximate manner.

In the example described, step 604 first comprises a step of thresholding the image. A threshold is thus chosen by analyzing a histogram of the image. For example, the threshold selection method described in Otsu N., entitled “A Threshold Selection Method from Gray-Level Histograms”, IEEE Transactions on Systems, Man, and Cybernetics, Vol. 9, No. 1, 1979, is used.

Step 604 further comprises a step of cleaning the image, in which each pixel of the image is modified according to its neighbors.

Step 604 further comprises a step of detecting groups of contiguous pixels in the image.

Step 604 further comprises rejecting groups of pixels that are too large or too small, i.e., more than a certain number of pixels or less than a certain number of pixels.

Step 604 further comprises a step of defining each remaining group of pixels as a first real area occupied by a respective capture site.

In a step 606, the update module 150 determines, from the first real areas, an overlay position and/or orientation correction.

With respect to the overlay orientation, in the example described, step 606 first comprises a step of determining a center of each first real area.

Returning to FIG. 6, step 606 further comprises, for at least one cell alignment, i.e., a set of grid cells having aligned centers, such as a row or column of the grid, a step of determining an empirical line passing closest to the respective centers of the first areas located in the cells of the alignment. This is because the capture sites generally move little from one update to the next, so that the area that each of them occupies remains in the same grid cell between two updates.

FIG. 8 illustrates the rows 802 near the centers 804 of the first areas in an example where the grid rows are used.

Returning to FIG. 6, a reference line is determined from the map 700. In the case where multiple parallel alignments are used (e.g., multiple rows or multiple columns of the grid), the reference line may be the direction of one of these alignments (either row direction or line direction).

Next, an average angle of the angles between the empirical lines and the reference line is determined. This average angle is, for example, taken as a correction for the orientation.

Concerning the overlay position, the step 606 comprises firstly, in the example described, for each of two alignments both comprising the same grid cell, a step of determining an empirical line passing as close as possible to the respective centers of the first real areas located in the cells of the alignment under consideration, and then a step of determining an intersection point of the two lines.

A reference point is determined from map 700. This is for example the center of a cell.

Then a correction of the overlay position is determined from the reference point and the determined intersection point, e.g., the vector from the reference point to the intersection point.

FIG. 8 illustrates the line 806 obtained for the first column of the grid. Thus, line 802 for the first row and line 806 for the first column intersect at intersection 810. This intersection 810 is the point where the center of the first cell 812 (first row, first column) of the grid 702 should be. The overlay position correction is then equal to the translation from the center of this cell 812 to the determined intersection 810.

In a step 608, the update module 150 updates the overlay position and/or orientation from the determined correction, keeping the position of each capture site shape in its cell.

The result of this step 608 is shown in FIG. 9.

Thus, the capture site shapes can be updated at the same time, allowing for rapid updating.

In order to improve the update, in a step 610, the update module 150 updates the position of each site shape in the map, i.e., in the example described its position in its cell.

In the described example, step 610 first includes a step of determining in the considered cell a second real area occupied by one of the capture sites. To this end, in the described example, the previously described steps of thresholding, cleaning the image, and detecting groups of contiguous pixels and rejecting groups of pixels that are too large or too small are implemented, but in the considered cell instead of the entire image. In addition, different parameters for these steps can be used. The objective is to determine, for each cell, a second real area occupied by the capture site 107 of that cell that is more accurate than the first area.

Step 610 further comprises a step of updating the position of at least one capture site shape in its cell from the second area of that cell.

In the example described, this local updating step comprises first a step of determining a center of the second area, and then a step of updating a center of the capture site shape of the cell under consideration to become the center of the second area.

For example, the update is performed when at least one center of a first real area located in the considered cell could be determined and when a center of the second real area located in the considered cell could be determined. Otherwise, the center of the capture site shape is not updated. This is for example the case when no first real area has been determined in the considered cell, which may indicate that the second real area found may be an artefact.

FIG. 10 shows the centers 1000 of the second real areas, and the updating (shown by arrows) of the centers 706 of the ellipses 704 for the first row of the grid 702, to the centers 1000 of the second real areas.

It clearly appears that a device and method such as those described previously provide good odor identification results, while keeping the imaging system compact and mechanically robust.

It should also be noted that the invention is not limited to the embodiments described above. Indeed, it will be apparent to those skilled in the art that various modifications can be made to the above-described embodiments, in the light of the teaching just disclosed.

For example, the method steps could be performed in any technically feasible order.

In addition, the spatial impulse response estimate could be determined from a theoretical plane of the test pattern, rather than the image g_{AF} sharpened by the presence of the focusing device 204.

In the above detailed presentation of the invention, the terms used are not to be interpreted as limiting the invention to the embodiments set forth in the present description, but are to be interpreted to include all equivalents the anticipation of which is within the grasp of those skilled in the art by applying their general knowledge to the implementation of the teaching just disclosed.

1. An odor identification device comprising:
capture sites adapted to capture odorous volatile organic compounds in an ambient air;
an imaging system adapted to image the capture sites designed to provide at least one raw image of the capture sites;
an unblurring module adapted to implement an unblurring filter using an estimate of a spatial impulse response of the imaging system, on an image to be unblurred that originates from at least one raw image of the capture sites; and
a module adapted to identify an odor from at least one image of the capture sites unblurred by the unblurring module.

2. The device as claimed in claim 1, wherein the imaging system comprises:
a metal layer having a first side in contact with the ambient air and on which the capture sites are fixed, as well as a second side opposite the first side;
a device adapted to illuminate the second side of the metal layer with collimated light, designed to produce a surface plasmon resonance on the first side of the metal layer, so that a reflectivity of the second side of the metal layer varies locally in the vicinity of each capture site as a function of the compound captured by that capture site; and
a camera arranged to receive collimated light that has been reflected by the second side of the metal layer, and designed to provide the raw image(s) of the capture sites.

3. The device as claimed in claim 1, wherein the unblurring filter is a Wiener filter comprising multiplication of a quantity W equal to E*/(|E|2+K) where E is the estimate in spectral form of the spatial impulse response of the imaging system, E* is the conjugate of this estimate E and K is a parameter, with the image to be unblurred in spectral form.

4. The device as claimed in claim 1, wherein the unblurring filter is an inverse filter comprising multiplying an inverse of the estimate in spectral form of the spatial impulse response of the imaging system with the image to be unblurred in spectral form.

5. The device as claimed in claim 1, wherein the identification module is adapted to use at least one unblurred image of the capture sites in presence of odor in the ambient air and at least one unblurred image of the capture sites in absence of odor in the ambient air.

6. An odor identification method using an odor identification device comprising:
capture sites adapted to capture odorous volatile organic compounds in an ambient air;
an imaging system adapted to image the capture sites designed to provide at least one raw image of the capture sites;
the method comprising:
an unblurring step implementing an unblurring filter using an estimate of a spatial impulse response of the imaging system on an image to be unblurred that originates from at least one raw image of the capture sites; and
a step for identifying an odor from at least one unblurred image of the capture sites.

7. The method as claimed in claim 6, further comprising, prior to the unblurring step:
a step for determining the spatial impulse response estimate of the imaging system; and
a step for configuring an unblurring module of the odor identification device so that the unblurring module implements the unblurring step.

8. The method as claimed in claim 6, wherein the spatial impulse response estimate of the imaging system is a predefined shape parameterized according to at least one parameter, and wherein the step for determining the spatial impulse response estimate of the imaging system comprises determining the parameter(s) of the predefined shape.

9. The method as claimed in claim 6, further comprising a step for determining at least one parameter of the unblurring filter.

10. A computer program downloadable from a communication network and/or recorded on a non-transitory computer-readable medium and/or executable by a processor, comprising instructions for executing the steps of a method as claimed in claim 6, when said program is executed on a computer.

11. A non-transitory computer-readable medium comprising instructions for executing the steps of a method as claimed in claim 6 when said instructions are executed on a computer.
